(19) United States
(12) Patent Application Publication
(10) Pub. No.: US 2021/0026092 A1
(43) Pub. Date: Jan. 28, 2021

(54) SUPPRESSING STIMULATED BRILLOUIN SCATTERING (SBS)

(71) Applicant: OFS Fitel, LLC, Norcross, GA (US)

(72) Inventors: Kazi S Abedin, Basking Ridge, NJ (US); David J DiGiovanni, Mountain Lakes, NJ (US); Tristan Kremp, Somerset, NJ (US)

(73) Assignee: OFS Fitel, LLC, Norcross, GA (US)

(21) Appl. No.: 16/969,011

(22) PCT Filed: Apr. 3, 2019
(86) PCT No.: PCT/US2019/025574

§ 371 Date: Aug. 11, 2020

Related U.S. Application Data
(60) Provisional application No. 62/651,906, filed on Apr. 3, 2018.

(51) Int. Cl. G02B 6/44; G02B 6/02; H01S 3/067

(52) U.S. Cl. CPC G02B 6/4477; G02B 6/4478; H01S 2301/03; H01S 3/06725; H01S 3/06716; G02B 6/02004

(57) ABSTRACT

An optical system comprising an optical conduit (e.g., gain fiber or rare-earth-doped fiber) with a bend having a bend radius (R). The bend induces a tension and a compression in the fiber core, which results in a corresponding strain (ε). The corresponding bend-induced strain impacts the signal properties in the core of the fiber.

### CROSS REFERENCE TO RELATED APPLICATIONS

This application claims the benefit of U.S. provisional patent application Ser. No. 62/651,906, filed Apr. 3, 2018, by Abedin, having the title “Suppression of Stimulated Brillouin Scattering Using Off Axis-Core Fiber,” which is incorporated herein by reference in its entirety.

### BACKGROUND

### Field of the Disclosure

The present disclosure relates generally to optical fibers and, more particularly, to suppression of stimulated Brillouin scattering (SBS) in optical fibers.

### Description of Related Art

A wide variety of fiber-optic nonlinear devices involve launching of continuous wave (CW) light into an optical fiber. Stimulated Brillouin scattering (SBS) sometimes limits the amount of light that can be launched into a fiber-optic device and, thus, there are ongoing efforts to reduce or suppress SBS.

### SUMMARY

The present disclosure provides systems and methods for reducing, modifying, or suppressing stimulated Brillouin scattering (SBS). Briefly described, in architecture, one embodiment is an optical system comprising an optical conduit (e.g., gain fiber or rare-earth-doped fiber) with a bend having a bend radius (R). The bend induces a tension and a compression in the fiber core, which results in a corresponding strain (F). The corresponding bend-induced strain impacts the signal properties in the core of the fiber.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing cross-sectional views at different axial positions (z) of one embodiment of an optical fiber that has been twisted so that the fiber core follows a substantially-helical path with a pitch (p).

FIG. 2 is a diagram showing one embodiment of the strain (ε) experienced in different sections of the offset (or off-axis) core when a bend (with bend radius of R) is applied to the optical fiber of FIG. 1.

FIG. 3 is a graph showing how F varies sinusoidally because of the helicity of the off-axis core of FIG. 1.

FIG. 4 is a graph showing one embodiment of averaged Brillouin gain spectra when the core of the fiber is subjected to various longitudinal strains.

FIG. 5 is a graph showing one embodiment in which suppression of Brillouin gain is plotted as a function of maximum longitudinal strain (εₘₐₓ) experienced by the off-axis core.

FIG. 6 is a graph showing one embodiment of enhancement in Brillouin gain bandwidth as a function of ε.

FIG. 7 is a diagram showing one embodiment of how a bend is applied to an off-axis core twisted fiber with a reel or a spool.

FIG. 8 is a diagram showing one embodiment of an amplifier using the off-axis core twisted fiber and reel of FIG. 7.

FIG. 9A is a diagram showing an off-axis core twisted fiber for core pumping.

FIG. 9B is a diagram showing an off-axis core twisted fiber for cladding pumping.

FIG. 10 is a diagram showing one embodiment of an optical nonlinear signal processing system using the off-axis core twisted fiber and reel of FIG. 7.

### DETAILED DESCRIPTION OF THE EMBODIMENTS

A wide variety of fiber-optic nonlinear devices (e.g., Raman amplifiers, parametric amplifiers, wavelength converters, etc.) involve launching of continuous wave (CW) light into an optical fiber. To increase conversion efficiency of nonlinear processes, it is often desirable to decrease mode-field diameter (MFD). However, a decrease in MFD typically leads to an increase in stimulated Brillouin scattering (SBS) of the CW-pump, which in turn limits the amount of light that can be launched into a fiber-optic device, thereby adversely affecting gain. While fiber length, mode-field area, dopant levels, and refractive index profiles directly affect threshold power at which SBS occurs, others have attempted to curtail SBS through external measures, such as temperature gradients along a fiber length, applications of external tensile strains along the fiber length, engineering refractive index (RI) profiles to control SBS spectral response, altering acoustic guiding properties of fibers by varying dopants, etc. Unfortunately, many of these techniques may not be viable in various circumstances. For example, maintaining a large temperature gradient may be impractical in many situations; applying external tensions may result in instability; and engineering RI profiles is difficult and costly. Consequently, there remains a need for optical fibers with increased Kerr or Raman effects without a proportional increase in SBS threshold and without special packaging or winding constraints.

To ameliorate several of these issues relating to SBS, the present disclosure provides systems and methods for reducing or suppressing SBS using a gain fiber (or other optical conduit) with a bend and an off-axis helically-disposed core within a glass cladding. The bend has a bend radius (R) and the substantially-helically-disposed core has a helical radius (Λ) (meaning, the off-axis core has a core center that is offset from the fiber center by Λ). Due to its helicity, the core experiences alternating tensions and compression along the bend with a pitch in the tension sections (pₜ) being greater than a pitch in the compression sections (p_{c}). These alternating tensions and compressions produce a substantially sinusoidal strain (ε) in the core, with F having a maximum value (εₘₐₓ) of approximately Λ/R. The alternating internal strain results in an optical fiber with improved SBS gain.

The fiber presented here comprises a core that is disposed at an offset from the center of a cladding with a circular axial cross section. In a more general case, however, the core merely needs to be disposed at an offset from the center of the overall structure that may include polymer coating or jacket that surround the optical fiber for the purpose of guiding light in the cladding (such as in double clad fiber) or providing additional mechanical strength. For example, the core of a glass optical fiber might be centered in the cladding, while the cladding is offset in the overall fiber structure. In another embodiment, both the signal fiber and pump fibers can coexist in the same coating, thereby resulting in a core that experiences bend-induced strains.

The fiber presented here is designed to have a helically-disposed core within the circular cladding. In a more general case, however, the core can be merely offset, and not helically disposed, from the cross-sectional center of the overall fiber structure, and the structure can be instead periodically bent, or periodically displaced above (positive displacement) and below (negative displacement) a two-dimensional plane that contains the axis located at the center of the overall fiber structure (also designated as a neutral plane, insofar as neither a tension nor a compression is applied in this two-dimensional plane). Similarly, the core can be merely offset, and not helically disposed, from the cross-sectional center of the overall fiber structure, and the structure can be wound around a spool that contains period corrugations for adding positive and negative displacements in the overall fiber structure away from the two-dimensional plane containing the central-axis of the overall fiber structure. All these arrangements impose periodic positive and negative strains in the radiation carrying core to suppress the SBS. However, this invention is not limited to the arrangement described above. Other arrangements can be considered for adding the qualitatively similar effect of imposing periodic positive and negative strains in the core for suppressing, or reducing, the SBS.

At bottom, as long as there is an offset core (e.g., helical core, core centered in the cladding but offset with reference to a coating central axis, core centered in the cladding but offset from a cable central axis, etc.) that experiences alternating tensions and compressions the precise mechanisms for how those tensions and compressions are applied (e.g., cylindrical spool, variable shaped spool, corrugated or undulating surface, etc.) are less important. Additionally, it should be appreciated that the alternating strains are applicable to many fiber parameters (e.g., stimulated Brillouin gain signature measured by back-reflected power, stimulated Brillouin gain, stimulated Brillouin gain bandwidth, Brillouin threshold, dispersion, etc.) that experience a strain effect.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

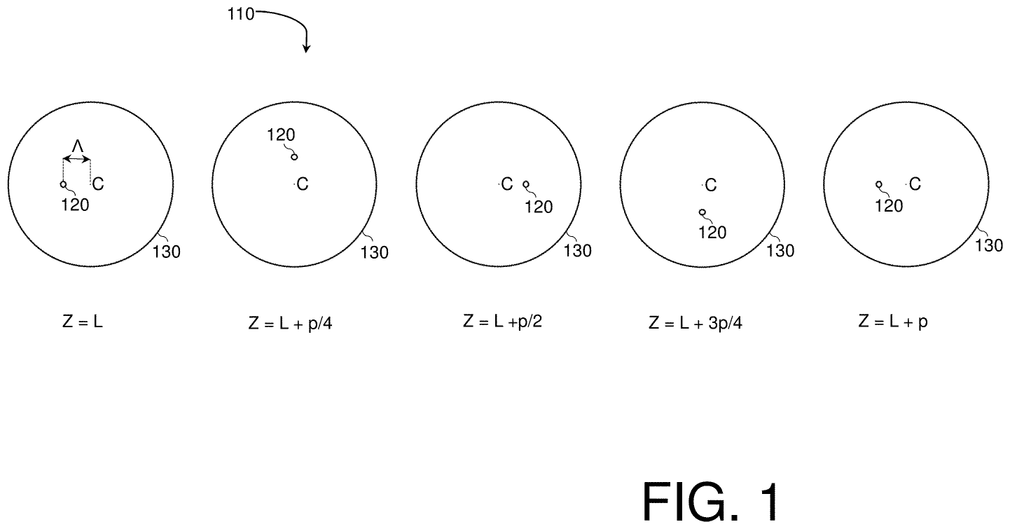

Notably, this disclosure teaches a highly nonlinear fiber core that is offset from the central longitudinal axis of the optical fiber and the optical fiber is twisted during draw or during winding so that there is a longitudinal variation in strain along the fiber core when the fiber is bent, thereby increasing the threshold for SBS. With this in mind, FIG. 1 is a diagram showing cross-sectional views at different axial positions (z) of one embodiment of a gain fiber 110 (or a rare-earth-doped fiber) with a core 120 and an inner cladding 130. The core 120 is offset from a central longitudinal axis (C) by an offset (Λ). The gain fiber 110 has been twisted so that the fiber core 120 follows a substantially-helical path with a pitch (p) and a helical radius of Λ. As shown in FIG. 1, starting from a first arbitrary location (L) and progressing along the longitudinal axis (z), the off-axis core 120 moves 90° with reference to C for each p/4 increment along z.

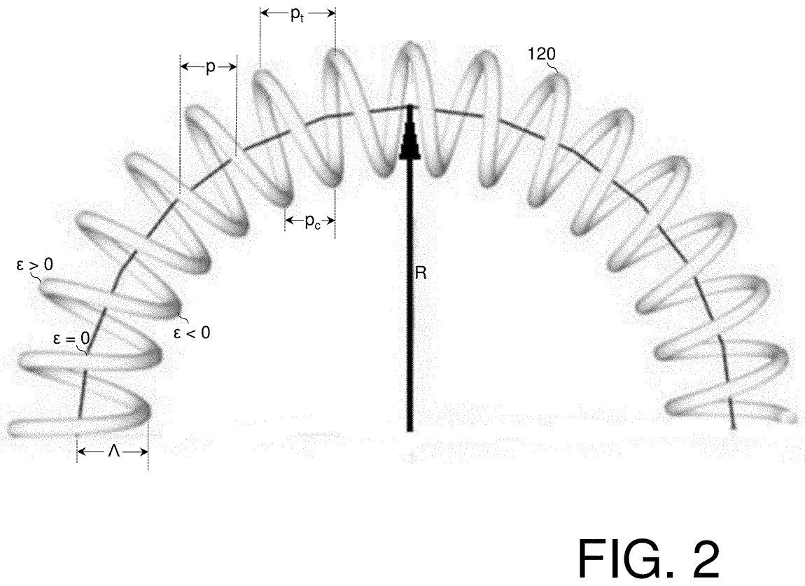

The practical effect of this rotation is shown in FIG. 2, which is a diagram showing one embodiment of the strain (ε) experienced in different sections of the off-axis core 120 when a bend (with bend radius of R at the longitudinal center of the gain fiber) is applied to the optical fiber 110. As the off-axis core 120 follows a helical path about the longitudinal axis, the sections that are toward the outside of the bend experience a tension and a corresponding tension strain (or positive strain of ε>0), while the sections that are toward the inside of the bend experience a compression and a corresponding compression strain (or negative strain of ε<0), with the maximum strain (εₘₐₓ) being proportional to R and Λ (εₘₐₓ≈Λ/R). For convenience, these sections are designated tension sections (for the outside of the bend) and compression sections (for the inside of the bend). Additionally, because of the bend, the tension sections exhibit a pitch (designated as tension pitch, pₜ) that is larger than the pitch at the compression sections (designated as compression pitch, p_{c}). As one can appreciate, the pitch (p) along R is the pitch of the off-axis core 120 during draw (when no strain is applied, or ε=0).

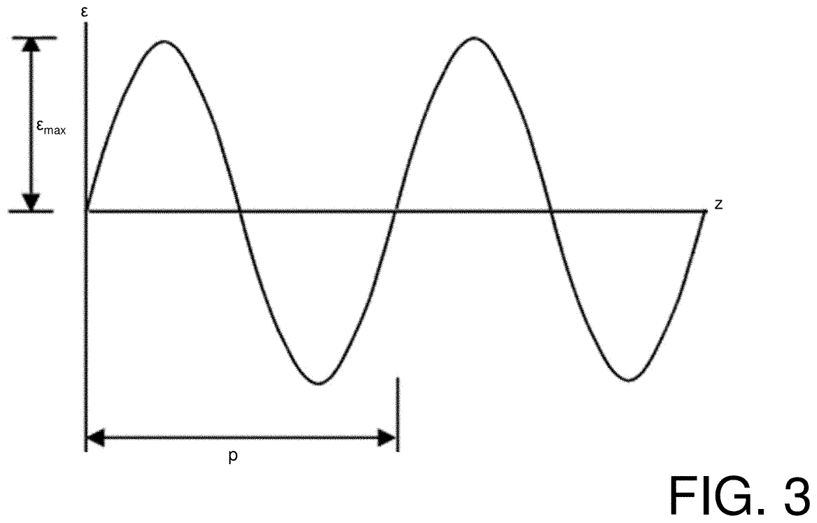

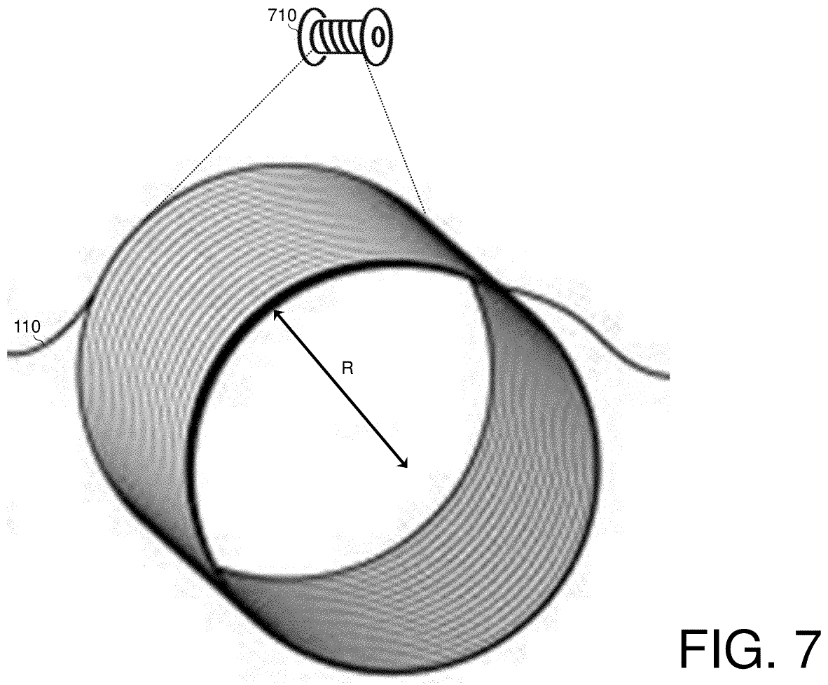

FIG. 3 is a graph showing how F varies sinusoidally because of the helicity of the off-axis core 120. As one can appreciate, this sinusoidally-varying periodic ε gradient along z results in an increased SBS threshold. One advantage of such an embodiment is that the periodically-varying ε is applicable to different core sizes and different index profiles. Insofar as no special RI profile is required, the periodically-varying ε is applicable to many different types of systems, such as, for example, Raman systems, highly nonlinear systems, etc. Furthermore, as one can appreciate, the periodically-varying F is also applicable to multicore fibers, insofar as each outer core in a multicore fiber is an off-axis core. Because the bend can be applied by winding the gain fiber 110 on a reel or a spool 710 (as shown in FIG. 7), there is no need for varying tensions and, consequently, no significant degradation of performance over time. Furthermore, because no temperature gradient is applied for SBS suppression, the helical structure results in savings for cost, space, and energy as compared to methods that require temperature fluctuations or temperature controllers.

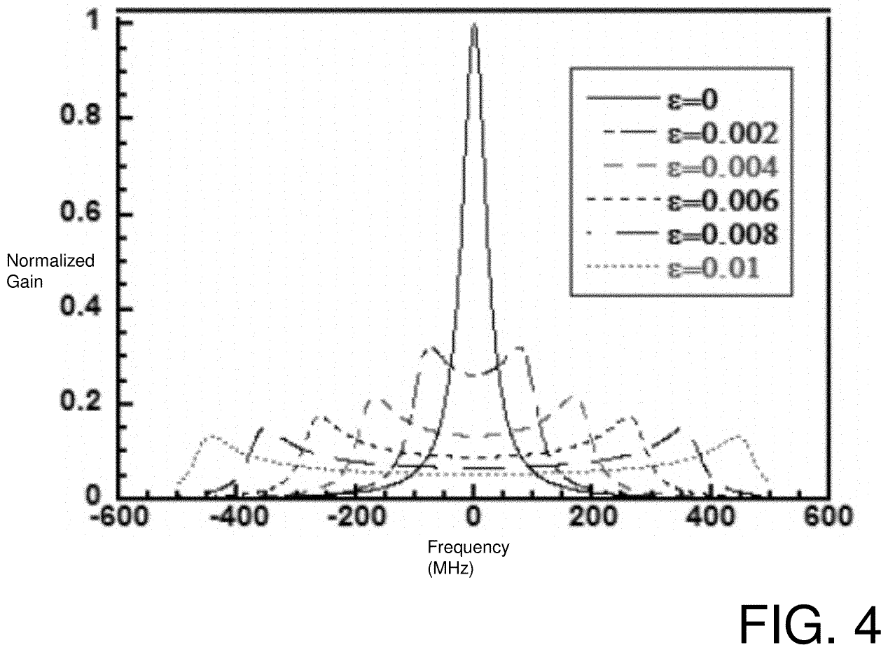

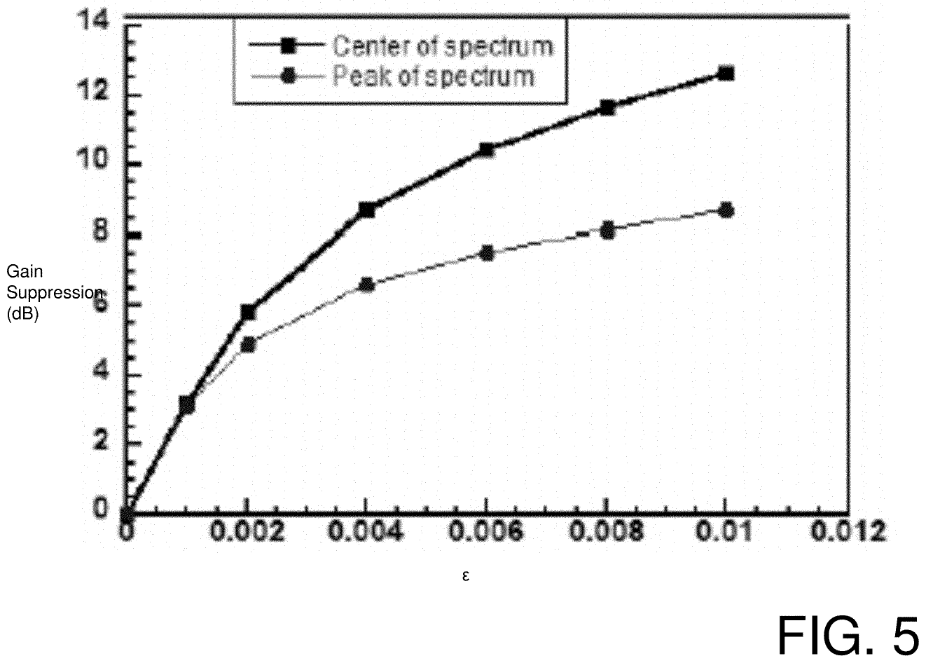

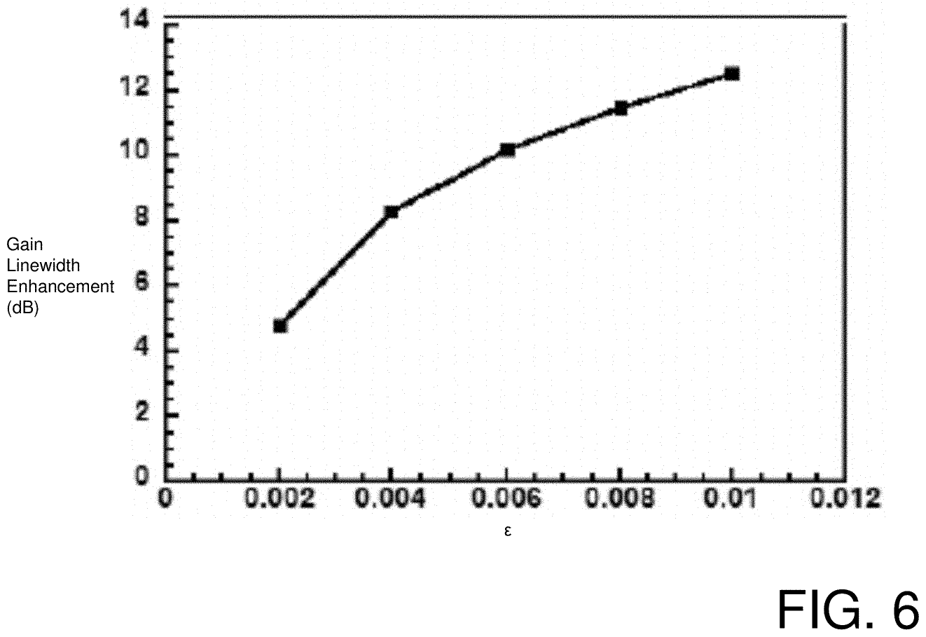

Continuing, FIG. 4 is a graph showing averaged Brillouin gain spectra when the core of the fiber is subjected to various longitudinal strains; FIG. 5 is a graph showing suppression of Brillouin gain is plotted as a function of maximum longitudinal strain (εₘₐₓ) experienced by the off-axis core; and FIG. 6 is a graph showing enhancement in Brillouin gain bandwidth as a function of strain (ε). In explaining FIGS. 4 through 6, it should be appreciated that the Brillouin gain coefficient that is induced by a narrowband laser radiation (meaning the laser linewidth is much smaller than the Brillouin linewidth) in the absence of any strain is represented as:

g(ν)=g₀/[1+(ν-ν_{B})²/(Δν_{B}/2)²] [Eq. 1],

where g₀ is the peak Brillouin gain, ν is the laser frequency, ν_{B} is the Brillouin frequency shift, and Δν_{B} is the Brillouin gain bandwidth. In silica fiber, the Brillouin gain bandwidth Δν_{B} is about 50 MHz. Although Eq. 1 assumes a narrowband laser radiation with linewidth much smaller than the Brillouin gain bandwidth Δν_{B}, in some instances, such as in high power lasers, a laser source can be considered narrowband when its linewidth is as high as 10× that of Δν_{B}.

In such cases, the Brillouin gain is still given by Eq. 1, but with a peak gain g₀ multiplied by Δν_{B}/(Δν_{B}+Δνₚ), where Δν_{P} is the 3 dB-bandwidth of the laser source. Without strain, the Brillouin threshold (Pₜₕ) can be expressed as:

Pₜₕ=21A_{eff}/L_{eff}·g_{B} [Eq. 2],

where A_{eff} is the effective area, L_{eff} is the effective length, and g_{B} is the Brillouin gain coefficient.

When a longitudinal strain (ε) is applied to the gain fiber, the SBS frequency shifts according to:

ν_{B}(ε)=ν_{B(ε=0)}+ν_{B(ε=0)}·C·ε [Eq. 3],

where ν_{B(ε=0)} represents the Brillouin frequency shift when no strain is applied, ε is the longitudinal strain (or tensile strain), and C is a constant (of approximately 4.6 for silica fibers).

When the bend radius (R) is small, axial strains (ε) change periodically from tension to compression (as shown in FIGS. 2 and 3). Consequently, the periodic variation in the SBS frequency shift due to strain can be expressed as:

ν_{B}(ε,z)=ν_{B(ε=0)}+ν_{B(ε=0)}·C·ε·cos(2πz/p+A) [Eq. 4],

where p represents pitch and A is a constant that depends on choice of reference, thereby resulting in:

g(ν)=g₀/[1+(ν-ν_{B(ε=0)}-ν_{B(ε=0)}·C·ε·cos(2πz/p+A))²/(Δν_{B}/2)²] [Eq. 5].

The Brillouin gain spectra averaged over a length (L) (with L being much greater p) is represented as:

$$\tilde{g} ( v ) = \frac{1}{L} {\int }_{0}^{L} g ( v ) dl . \qquad [ Eq . 6 ]$$

Averaged gain spectra for different amounts of strain are shown in FIG. 4. As seen in FIG. 4, in the absence of strain, the curve is Lorentzian. However, with the application of strain, the curve becomes double-peaked. As strain increases, the peaks separate while the center becomes more suppressed. In other words, SBS is suppressed as the profile (or spectrum) spreads. The gain suppression at the center of the profile is shown in FIG. 5 and the full width of the broadened gain spectrum is plotted as a function of strain in FIG. 6. By way of example, the peak gain is suppressed by approximately six (6) decibels (dB) for a strain of approximately 0.003.

It should be appreciated that the SBS of a narrowband signal is adjustable by at least 3 dB (as compared to an average stimulated Brillouin (SBS) gain, which is the SBS gain averaged over the entire optical fiber) when a corresponding amount of strain is applied. Additionally, although an example of εₘₐₓ≈0.003 is provided as an example, it should be appreciated that εₘₐₓ≈0.001 (or greater) provides a sufficient adjustment in the narrowband signal for certain optical applications. For silica fibers, where ν_{B} is approximately 10 GHz, a strain of εₘₐₓ≈0.001 will cause a change in Brillouin frequency shift by approximately 46 MHz according to Eq. 3.

The longitudinal strain (ε) that is greater than 0.003 (ε>0.003) is obtainable by winding the gain fiber on a spool 710, as shown in FIG. 7, which illustrates the spool 710 and an enlarged view of the configuration of the gain fiber 110 on the spool 710. When the core 120 has an offset (Λ) of approximately 45 micrometers (μm) and a twist of approximately fifty (50) turns per meter (m) is imparted on the fiber 110, a reel or spool radius (R) of approximately three (3) centimeters (cm) produces a strain that is greater than approximately 0.003 due to the relationship εₘₐₓ≈Λ/R.

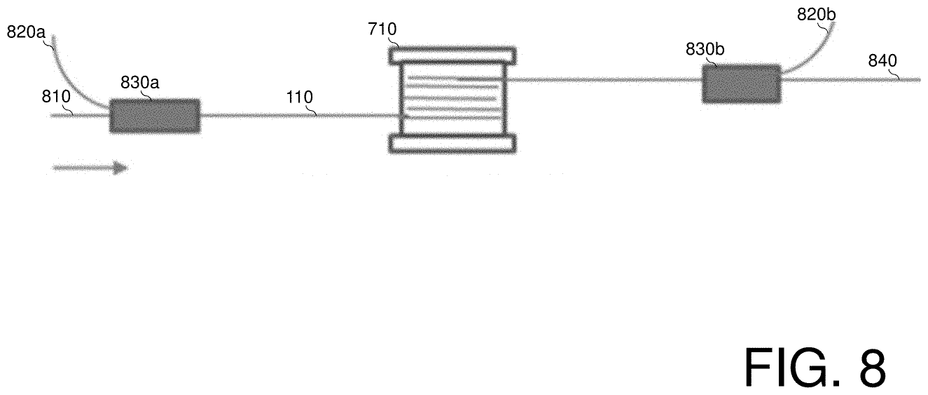

By way of example, the Brillouin threshold of an off-axis (or offset) core twisted fiber 110 can be approximately 6 dB to approximately 8 dB higher than a conventional optical fiber with a similar mode-field area. Optical fibers with increased Brillouin thresholds are useful when high-power single-frequency or narrow-band laser radiation is transmitted through the off-axis core twisted fiber 110. Examples, such as, Raman amplifier systems, parametric amplifier systems, or rare-earth-doped amplifier systems, are shown with reference to FIG. 8.

As shown in FIG. 8, an amplifier system comprises a signal input structure, such as, for example, a signal fiber 810. The signal fiber 810 introduces a narrow-band laser input signal, such as, for example, a single-frequency laser input signal. In addition to the signal fiber 810, the amplifier system comprises a pump input structure, such as, for example, a pump fiber 820a that receives pump light. The signal and the pump are combined in a signal-pump combining structure, such as, for example, a signal-pump combiner 830a. The off-axis core twisted fiber 110 is optically coupled to an output of the signal-pump combiner 830a and subsequently wound on a spool 710, thereby imparting a longitudinal strain, which in turn suppresses SBS. By way of example, a spool 710 that imparts εₘₐₓ≈0.005 provides approximately 10 dB gain linewidth enhancement, as shown in FIG. 6.

It is also possible that the pump comprises one or more narrowband laser radiation(s) and signal is a broadband modulated light, such as modulated pulse train, both being launched into the amplifier system in order to amplify the signal through parametric (four wave mixing) process.

As shown in FIG. 8, the off-axis core twisted fiber 110 (also denoted as a gain fiber or rare-earth-doped fiber) can be counter-pumped by adding signal-pump combiner 830b and a pump fiber 820b at the output of the gain fiber 110, with the narrow-band laser output exiting through an output fiber 840. Those having skill in the art will appreciate that the system can be configured for co-pumping (820a, 830a), counter-pumping (820b, 830b), or both (820a, 820b, 830a, 830b).

Specifically, for rare-earth (RE) amplification, the off-axis core twisted gain fiber 110 is doped with a RE dopant, such as, for example, erbium (Er). For Raman amplification or nonlinear parametric amplification, the off-axis core twisted gain fiber 110 is doped with a nonlinearity-enhancing dopant, such as, for example, germanium oxide (GeO₂) or aluminum (Al).

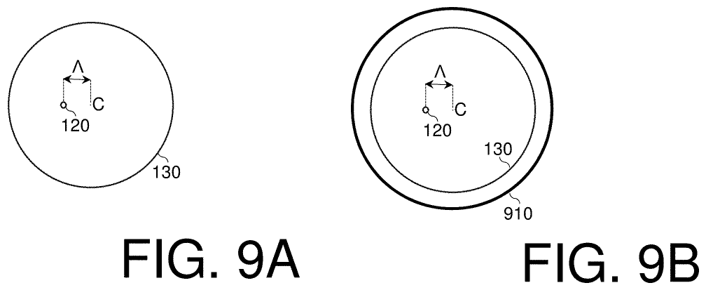

Continuing, both an off-axis core twisted fiber 110 for core pumping (FIG. 9A) and an off-axis core twisted fiber for cladding pumping (FIG. 9B) are shown. As seen in FIGS. 9A and 9B, for core pumping the off-axis core twisted fiber comprises an off-axis core 120 and an inner cladding 130 surrounding the off-axis core 120. For cladding pumping, the off-axis core twisted fiber further comprises an outer cladding 910, which permits introduction of pump light guided by the outer cladding 910. The outer cladding 910 surrounds the inner cladding 130.

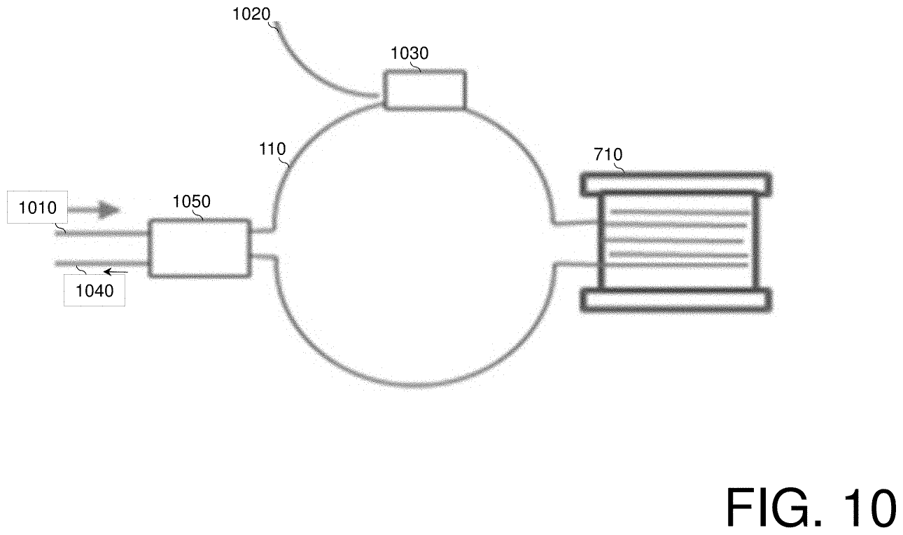

FIG. 10 is a diagram showing one embodiment of an optical nonlinear signal processing system, using the off-axis core twisted fiber 110 and reel 710 of FIG. 7. In the embodiment of FIG. 10, which relies on propagation of continuous wave (CW) laser radiation through a nonlinear fiber, the SBS threshold is increased by using the off-axis core twisted fiber 110 and spool 710 in the context of a nonlinear optical loop mirror (NOLM). As such, the embodiment of FIG. 10 comprises an input fiber 1010, which receives a narrow-band laser input or a single-frequency laser input. The input fiber 1010 is optically coupled to an input of a 3 dB optical coupler 1050. A control signal is input to a coupler 1030 (e.g., wavelength division multiplexer (WDM) or polarization beam splitter (PBS)) through a control signal input 1020, along with the input signal. The off-axis core twisted fiber 110 and spool 710 are optically coupled between the output of the coupler 1030 and the 3 dB optical coupler 1050. An output fiber 1040 coupled to the 3 dB optical coupler 1050 permits output of the processed signal.

As shown with reference to FIGS. 1 through 10, various embodiments of optical systems are shown for suppressing or reducing SBS, which produces a corresponding improvement in gain. By providing a gain fiber with a bend and an off-axis core, which follows a substantially-helical path, the off-axis core experiences alternating tensions and compression along the bend with a pitch in the tension sections (pₜ) being greater than a pitch in the compression sections (p_{c}). These alternating tensions and compressions produce a substantially sinusoidal strain (ε) in the core, with F having a maximum value (εₘₐₓ) of approximately Λ/R (εₘₐₓ≈Λ/R); and, this sinusoidally-varying tension provides an improved mechanism for suppressing SBS as compared to conventional approaches to suppressing SBS.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An optical system comprising:
a signal fiber for receiving a narrowband signal;
a pump fiber for pumping the narrowband signal; and
a rare-earth-doped fiber coupled to the signal fiber, the rare-earth-doped fiber comprising:
a bend having a bend radius (R);
a tension section induced by the bend, the tension section having a positive strain (+ε);
a compression section induced by the bend, the compression section having a negative strain (−ε); and
wherein:
the positive strain (+ε) and the negative strain (−ε) alter the narrowband signal;

|ε|≤εₘₐₓ; and
εₘₐₓ>0.001.

2. The system of claim 1, wherein εₘₐₓ>0.003.

3. The system of claim 1, wherein the rare-earth-doped fiber comprises a dopant selected from the group consisting of:
erbium (Er);
ytterbium (Yb);
germanium oxide (GeO₂);
lanthanum (La); and
aluminum (Al).

4. The system of claim 1, further comprising a bend structure for forming the bend, the bend structure being one selected from the group consisting of:
a cylindrical spool;
a variable shaped spool; and
a corrugated surface.

5. An optical fiber for propagating a narrowband signal, the optical fiber comprising:
an average stimulated Brillouin scattering (SBS) gain;
a bend having a bend radius;
tension sections induced by the bend, the tension sections having a positive strain (+ε);
compression sections induced by the bend, the compression sections having a negative strain (−ε); and
wherein the tension sections and the compression sections alter the average SBS gain by at least three (3) decibels (dB).

6. The optical fiber of claim 5, wherein the tension sections and the compression sections alternate along the length of the bend to reduce the average SBS gain by at least 3 dB.

7. The optical fiber of claim 5, further comprising an offset core, wherein the offset core is one selected from the group consisting of:
a helical core;
a core centered within the inner cladding but offset from a coating central axis; and
a core centered within the inner cladding but offset from a cable central axis.

8. The optical fiber of claim 7, wherein the core experiences a sinusoidal strain.

9. An optical conduit coupled to a signal input structure, the optical conduit comprising:
a bend having a bend radius (R), the bend for inducing a change in an optical parameter of a narrowband signal propagating through the optical conduit, the optical parameter being one selected from the group consisting of:
stimulated Brillouin gain signature measured by back-reflected power;
stimulated Brillouin gain;
stimulated Brillouin gain bandwidth;
a Brillouin threshold; and
dispersion;
tension sections induced by the bend, the tension sections having a positive strain (+ε);
compression sections induced by the bend, the compression sections having a negative strain (−ε); and
wherein:

|ε|≤εₘₐₓ; and
εₘₐₓ>0.001.

10. The optical conduit of claim 9, wherein εₘₐₓ>0.003.

11. The optical conduit of claim 9, wherein the optical conduit resides in an optical system, the optical system being one selected from the group consisting of:
a Raman amplifier;
a parametric amplifier; and
an acoustic sensor.

12. The optical conduit of claim 9, further comprising a rare-earth (RE) dopant.

13. The optical conduit of claim 12, the rare-earth (RE) dopant being erbium (Er).

14. The optical conduit of claim 9, further comprising a nonlinearity-enhancing dopant.

15. The optical conduit of claim 14, the nonlinearity-enhancing dopant being germanium oxide (GeO₂).

16. The optical conduit of claim 9, wherein R is approximately fifteen (15) millimeters (mm).
